(19) United States
(12) Patent Application Publication
(10) Pub. No.: US 2025/0199226 A1
(43) Pub. Date: Jun. 19, 2025

(54) POLARIZATION ABERRATION COMPENSATION FOR REFLECTIVE SURFACES

(71) Applicant: Arizona Board of Regents on Behalf of the University of Arizona, Tucson, AZ (US)

(72) Inventors: Sawyer Miller, Tucson, AZ (US); Linan Jiang, Tucson, AZ (US); Stanley Pau, Tucson, AZ (US)

(21) Appl. No.: 18/845,162

(22) PCT Filed: Mar. 9, 2023
(86) PCT No.: PCT/US2023/064028

§ 371 Date: Sep. 9, 2024

Related U.S. Application Data
(60) Provisional application No. 63/269,065, filed on Mar. 9, 2022.

(51) Int. Cl. G02B 5/30; G02B 1/116; G02B 27/00

(52) U.S. Cl. CPC G02B 5/3083; G02B 1/116; G02B 5/3066; G02B 27/0025

(57) ABSTRACT

Methods, devices and systems are described that reduce polarization aberration of a metal coated surface. An example optical device includes a multi-layer structure that includes a reflective layer having retardance and diattenuation over a particular range of wavelengths. The multi-layer structure also includes a uniaxial birefringent layer positioned above the reflective layer, and an anti-reflection layer positioned above the uniaxial birefringent layer. The uniaxial birefringent layer's thickness is selected to compensate for at least a portion of the retardance of the reflective layer over the particular range of wavelengths. The anti-reflection layer's thickness is selected to compensate for at least a portion of the diattenuation associated with the reflective layer over the particular range of wavelengths. The uniaxial birefringent layer can be a C-plate, and example reflective layers include an aluminum layer, a silver layer or a gold layer.

### CROSS-REFERENCE TO RELATED APPLICATION(S)

This application claims priority to the provisional application with Ser. No. 63/269,065 titled “Polarization Aberration Compensation for Reflective Surfaces,” filed Mar. 9, 2022. The entire contents of the above noted provisional application are incorporated by reference as part of the disclosure of this document.

### TECHNICAL FIELD

The description in this patent document relates to devices and method that improve performance of optical surfaces by reducing polarization aberrations.

### BACKGROUND

Reflective surfaces are used in many optical devices and constitute basic components that reflect incident light. For many applications, reflective surfaces, or mirrors, should have high reflectivity and should not change the properties of light after reflection. Excluding the direction of propagation, the properties of light include amplitude, coherence, wavelength, and polarization state. Mirrors, however, can act as a polarizer and an optical retarder, thus introducing unwanted polarization aberration by changing the polarization state of the incident light.

### SUMMARY

The disclosed embodiments relate to methods, devices and systems that, among other features and benefits, reduce the polarization aberration of a metal coated mirror by reducing both the diattenuation and retardance of the mirror. The disclosed technology has applications in thin film coating, polarimetry, interferometry, metrology, telecommunication, display and imaging, and other technologies.

One example optical device includes a multi-layer structure configured to compensate for polarization aberrations. The multi-layer structure includes a reflective layer having retardance and diattenuation over a particular range of wavelengths, and a uniaxial birefringent layer positioned above the reflective layer. The uniaxial birefringent layer having a thickness that is selected to compensate for at least a portion of the retardance associated with the reflective layer over the particular range of wavelengths. The multi-layer structure also includes an anti-reflection layer positioned above the uniaxial birefringent layer. The anti-reflection layer has a thickness that is selected to compensate for at least a portion of the diattenuation associated with the reflective layer over the particular range of wavelengths. The uniaxial birefringent layer and the anti-reflection layer are positioned to allow incident polarized light to pass through the anti-reflection layer and through the uniaxial birefringent layer to reach the reflective layer, and upon reflection from the reflective layer to pass through the uniaxial birefringent layer and then through anti-reflection layer.

### BRIEF DESCRIPTION OF THE DRAWINGS

FIG. 1A illustrates plots of an ideal Mueller matrix for reflection as a function of wavelength and for a range of incidence angles.

FIG. 1B illustrates example plots of normalized Mueller matrix elements for reflection from aluminum in air at different angles of incidence.

FIG. 1C illustrates magnified versions of some of the elements of FIG. 1B.

FIG. 2 illustrates an optical system that includes an AR coating on top a uniaxial birefringent layer in accordance with an example embodiment.

FIG. 3A illustrates an example uncorrected Mueller matrix for aluminum.

FIG. 3B illustrates magnified versions of some of the elements of FIG. 3A.

FIG. 4A illustrates a corrected Mueller matrix for aluminum that uses a negative C-plate and anti-reflection coating in accordance with an example embodiment.

FIG. 4B illustrates magnified versions of some of the elements of FIG. 4A.

FIG. 5 illustrates example plots of diattenuation, reflectance, reduction in diattenuation and retardance, for the configuration that corresponds to FIG. 4A.

FIG. 6A illustrates an example uncorrected Mueller matrix for silver.

FIG. 6B illustrates magnified versions of some of the elements of FIG. 6A.

FIG. 7A illustrates a corrected Mueller matrix for silver that uses a negative C-plate and anti-reflection coating in accordance with an example embodiment.

FIG. 7B illustrates magnified versions of some of the elements of FIG. 7A.

FIG. 8 illustrates example plots of diattenuation, reflectance, reduction in diattenuation and retardance, for the configuration that corresponds to FIG. 7A.

FIG. 9A illustrates an example uncorrected Mueller matrix for gold.

FIG. 9B illustrates magnified versions of some of the elements of FIG. 9A.

FIG. 10A illustrates a corrected Mueller matrix for gold that uses a negative C-plate and anti-reflection coating in accordance with an example embodiment.

FIG. 10B illustrates magnified versions of some of the elements of FIG. 10A.

FIG. 11 illustrates example plots of diattenuation, reflectance, reduction in diattenuation and retardance, for the configuration that corresponds to FIG. 10A.

FIG. 12 lists example thicknesses for negative C-plate material and anti-reflection coatings for aluminum, silver and gold obtained in accordance with example embodiments.

FIG. 13 is an example diagram illustrating classes of materials that are categorized in accordance with their real index of refraction and absorption coefficient.

FIG. 14 illustrates a set of operations that can be carried out to provide a multi-layer structure that compensates for polarization aberrations in accordance with an example embodiment.

### DETAILED DESCRIPTION

The most common mirror is the metal coated mirror, which is made of a thin metal coating on a flat or curved substrate. The substrate surface is polished to a fraction of a wavelength to reduce scattering loss. Example metal coatings include gold, silver, aluminum, beryllium, copper, chrome, molybdenum and other alloys, such as nickel/chrome and beryllium/copper. Substrate can be glass, semiconductor and/or other metal. Mirrors are often manufactured by electro-plating, vacuum evaporation or sputtering techniques. The conventional metal coated mirror is widely used because it is low cost, durable and easy to manufacture and has broadband reflectivity and low chromatic dispersion. Compared to a dielectric mirror, such as those made of multiple layers of alternating dielectric materials, the metal coated mirror generally has a lower reflectivity and, as a consequence, a lower damage threshold. In addition, a metal coated mirror has a finite diattenuation and retardance at different angles of incidence, because the metal in the mirror has a complex refractive index. As a direct consequence, a metal coated mirror can act as a weak polarizer and an optical retarder, and can introduce unwanted polarization aberration by changing the polarization state of the incident light. As examples of undesirable effects, linear polarized light is converted to elliptically polarized light, and unpolarized light is converted to partially polarized light.

### Mueller Matrix and Component of Polarization Aberration: Diattenuation and Retardance

The following description facilitates the understanding of the disclosed embodiments. To quantify the polarizing properties of a mirror, the Mueller-Stokes and Jones calculi are often used. All polarizing parameters of the mirror are included in the Jones matrix, a 2×2 matrix, describing diattenuation and retardance, and the Mueller matrix, a 4×4 matrix, describing the diattenuation, retardance, and depolarization an optic may introduce. The Jones matrix can be represented using the following matrix element notation:

$$J = [ \begin{matrix}{j}_{xx} & {j}_{xy} \\ {j}_{yx} & {j}_{yy}\end{matrix} ] \qquad ( 1 )$$

Reflection from mirrors introduces diattenuation as well as retardance due to the complex valued refractive index of metals, incurring absorption. A Jones matrix can be defined for the s- and p-polarization components shown in Equation (2).

$${J}_{sp} = [ \begin{matrix}{x}_{s} & 0 \\ 0 & {x}_{p}\end{matrix} ] \qquad ( 2 )$$

where xₛ and xₚ are the Fresnel transmission or reflection coefficients for s- and p-polarized light respectively. The ideal Jones matrix for reflection is shown below in Equation (3).

$$r = [ \begin{matrix}1 & 0 \\ 0 & - 1\end{matrix} ] \qquad ( 3 )$$

Ideally, the Jones matrix of a mirror should be equal to r over a band of wavelengths; however due to dispersion of materials, differing amounts of diattenuation and retardance are introduced as a function of wavelength. Additionally, the diattenuation and retardance is a function of the angle of incidence (AOI) of the light directed on the material. This is described by the Fresnel equations.

To calculate diattenuation and retardance, the singular value decomposition of Equation (2) is performed, resulting in three matrices, where † denotes adjoint.

$${J}_{sp} = W \cdot D \cdot {V}^{†} \qquad ( 4 )$$

In Equation (4), D is a diagonal matrix, and W and V are complex-valued unitary matrices. Using Equation (4), the singular values of Jₛₚ are the diagonal values of the matrix D. To calculate diattenuation, the following operation is performed.

$$d = \frac{{D}_{1 , 1}^{2} - {D}_{2 , 2}^{2}}{{D}_{1 , 1}^{2} + {D}_{2 , 2}^{2}} \qquad ( 5 )$$

Retardance is calculated using the matrices W and V, producing the pure unitary retarder portion of Jₛₚ as follows:

$$U = W \cdot V \qquad ( 6 )$$

The eigenvalues are calculated for U as ξₛ and ξₚ. The retardance is then calculated as:

$$ϕ = \vert arg ( {ξ}_{s} ) - arg ( {ξ}_{p} ) \vert \qquad ( 7 )$$

An ideal reflection produces a retardance of 180 degrees. The Mueller matrix can be represented using the following matrix notation:

$$M = [ \begin{matrix}{m}_{0 , 0} & {m}_{0 , 1} & {m}_{0 , 2} & {m}_{0 , 3} \\ {m}_{1 , 0} & {m}_{1 , 1} & {m}_{1 , 2} & {m}_{1 , 3} \\ {m}_{2 , 0} & {m}_{2 , 1} & {m}_{2 , 2} & {m}_{0 , 0} \\ {m}_{3 , 0} & {m}_{3 , 1} & {m}_{3 , 2} & {m}_{0 , 0}\end{matrix} ] \qquad ( 8 )$$

The Mueller matrix for an ideal reflection can easily be calculated from Equation (3) as the following:

$$R = [ \begin{matrix}1 & 0 & 0 & 0 \\ 0 & 1 & 0 & 0 \\ 0 & 0 & - 1 & 0 \\ 0 & 0 & 0 & - 1\end{matrix} ] \qquad ( 9 )$$

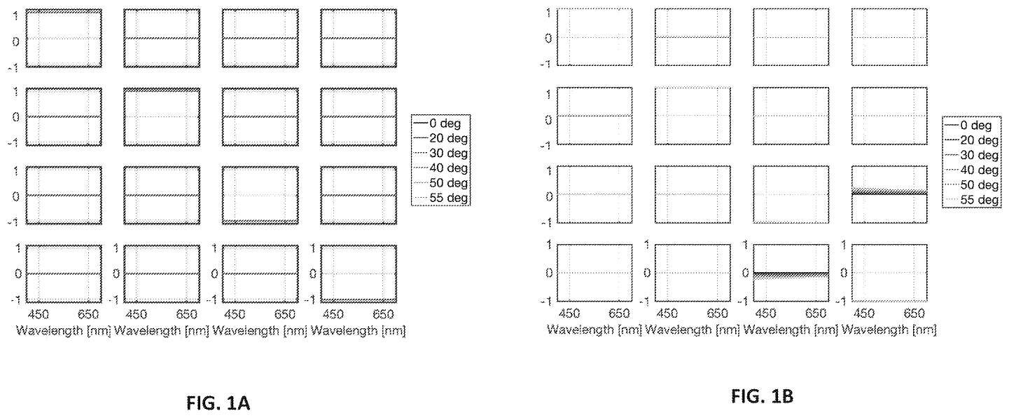

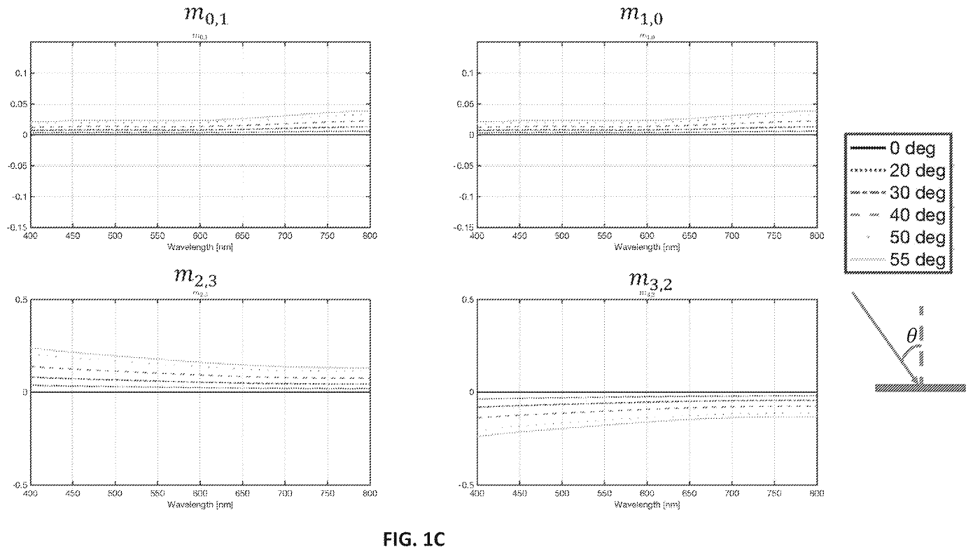

FIG. 1A shows the ideal Mueller matrix for reflection as a function of wavelength and for a range of incidence angles. Each square represents one Mueller matrix element. The plots in FIG. 1A show the ideal reflection results in conformance with Equation (9), with the plots for all angles of incidence coinciding on top of one another. FIG. 1B shows example normalized Mueller matrix elements for reflection from aluminum in air at angles of incidence ranging from 0 to 55 degrees. FIG. 1C illustrates magnified versions of elements m_{0,1}, m_{1,0}, m_{2,3}, and m_{3,2} of FIG. 1B to illustrate the separation of plots for different angles of incidence. The various fields plotted correspond to increasing angles of incidence indicating a non-uniform response of the material as a function of wavelength and angle of incidence, and illustrate the deviations of the diagonal elements from the ideal plots of FIG. 1A. The amount of retardance and diattenuation observed is a function of both the wavelength and angle of incidence, creating unwanted polarization aberrations. In these plots, s-polarization is considered horizontal, and p-polarization is considered vertical.

FIG. 1B shows that reflection of light by aluminum coating introduces both a retardance between s- and p-polarization states as well as a diattenuation between s- and p-polarization states. These two polarization aberrations will be treated separately. The retardance can be corrected using a layer of negative C-plate liquid crystal polymer (LCP) material, or more generally a thin film of uniaxial birefringent material. The negative C-plate generally has a negative birefringence along the optical axis along its thickness direction. Negative C-plate material is chosen as the negative uniaxial behavior is suitable to correct the retardance between s- and p-polarization states. According to the disclosed embodiments, the thickness of the birefringent material can be optimized by defining and minimizing a merit function. Equation (10) describes the calculation of the complete Jones matrix of the optical system, where A is Fresnel reflection (e.g., from aluminum), C is the C-plate material, and F₁ and F₂ are the Fresnel reflections associated with the anti-reflection (AR) coating interface. The use of an AR coating is important for high performance, especially for reduction in diattenuation.

$$J = {F}_{2} \cdot C \cdot A \cdot C \cdot {F}_{1} \qquad ( 10 )$$

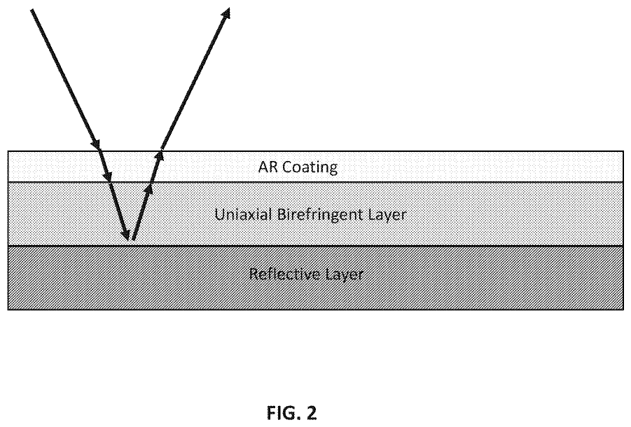

FIG. 2 illustrates an example optical system that includes an AR coating on top a uniaxial birefringent layer (e.g., C-plate), which is placed above the reflective layer (e.g., metallic layer such as aluminum), which satisfies the requirements in Equation (10). Comparing Equations (5) and (7) allows for the optimization of the thicknesses in C, the C-plate material, and F, the AR coating. For example, one particular merit function can be described in Equation (11) below.

$${υ}_{λ , θ} = {\sum }_{λ = 400 nm}^{800 nm} {\sum }_{θ = 0 deg}^{55 deg} \sqrt{{d ( λ , θ )}^{2} + {( 180 - ϕ ( λ , θ ) )}^{2}} \qquad ( 11 )$$

In Equation (11), d is the diattenuation of J, and ϕ is the retardance of J. In the example merit function of Equation (11), the desired or optimal retardance is 180 degrees. Other merit functions can also be implemented that allow the thicknesses of layers to be determined to achieve a particular diattenuation and/or retardance with dependence on wavelength and angle of incident light. It should be noted that the angles of incidence on the metal layer, uniaxial birefringent layer, and the AR layer are related to one another, and knowing any one of those angles allows the others to be computed using, for example, the Snell's law.

In some embodiments, υ_{λ,θ} in Equation (11) is minimized as function of wavelength and angle of incidence to calculate optimal thicknesses of C, the C-plate material, and F, the AR coating, where the retardance and diattenuation are both corrected for wavelength and angle of incidence variations.

The coating of uniaxial birefringent layer can be applied directly onto the metal surface or on a separate substrate, allowing for placement anywhere in the optical path. In some embodiments, an additional layer may be present between the uniaxial birefringent material (e.g., the negative C-plate layer) and the metal. For example, in some scenarios, a layer of aluminum oxide may be formed therebetween due to exposure to oxygen in the air. In some embodiments, the merit function is modified to optimize or achieve a particular level of (e.g., minimum) diattenuation only, minimum retardance only, for a specific wavelength band or bands, a specific angle range or ranges, or combinations of the aforementioned. An example application is to create a metal coated mirror that has low polarization aberration.

In some embodiments, the merit function can be modified to optimize or to achieve a particular level of (e.g., maximum) diattenuation only, retardance only, for a specific wavelength band or bands, a specific angle range or ranges, or combinations of the aforementioned. An example application is to create a metal coated mirror that has high polarization aberration. While in the description, the terms optimize, maximum and minimum are used, these terms do not necessarily mean the most extreme values (e.g., the absolute maximum, minimum or absolute best outcome). These terms must rather be construed in view of practical implementation and manufacturing capabilities of the components, as well as the cost-benefit tradeoff.

In general, the merit function can be modified to optimize a specific value of diattenuation only, a specific value of retardance only, a specific wavelength band or bands, a specific angle range or ranges, or combinations of the aforementioned. An example application is to create a metal coated mirror that has a specific polarization aberration.

To account for the dispersion of the negative C-plate, a modified single band dispersion model can be used. The retardance (δ) of the negative C-plate can be calculated using Equation (12).

$$δ ( λ , θ ) = Ct \frac{λ {λ}^{* 2}}{{λ}^{2} - {λ}^{* 2}} {sin}^{2} θ \qquad ( 12 )$$

In the above equation, λ* is the resonant wavelength, θ is the angle of incidence, λ is the wavelength of interest, and Ct is a parameter linearly proportional to the thickness of the LCP layer. In particular, Ct is the thickness of a reference (or standard) negative C-plate material with known characteristics. For example, measurements of a standard negative C-plate can be taken as a function of wavelength and angle of incidence and fit to Equation (12). For an example standard sample, Ct is equal to 0.256 and λ* is equal to 197.3 nm. Thicknesses of the negative C-plate are represented using corresponding Ct values for example embodiments disclosed herein.

### Example Embodiments Using Negative C-Plate Material and Anti-Reflection Coating for Gold, Silver and Aluminum

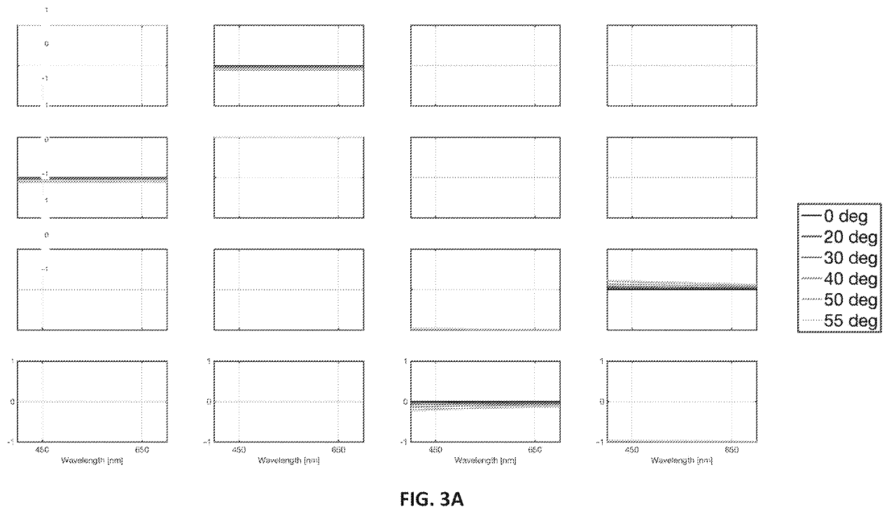

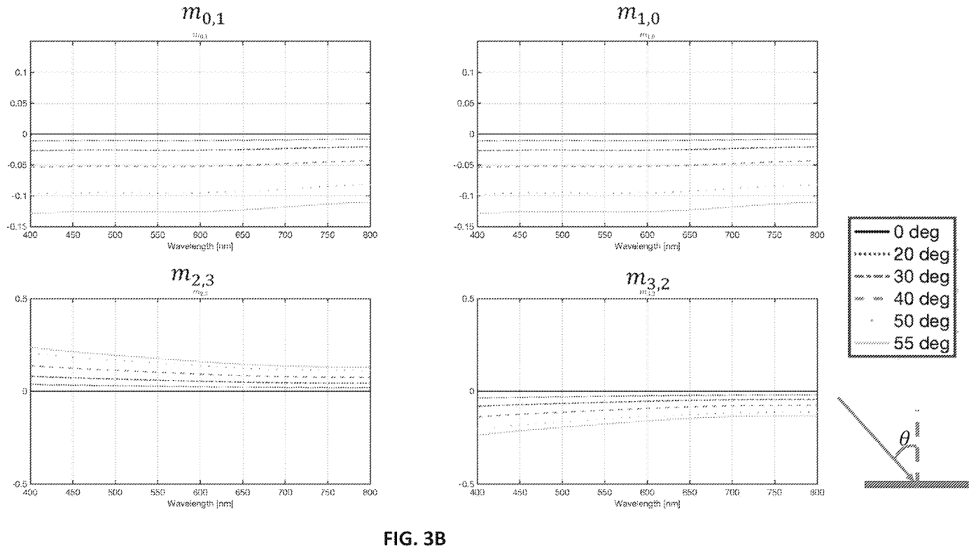

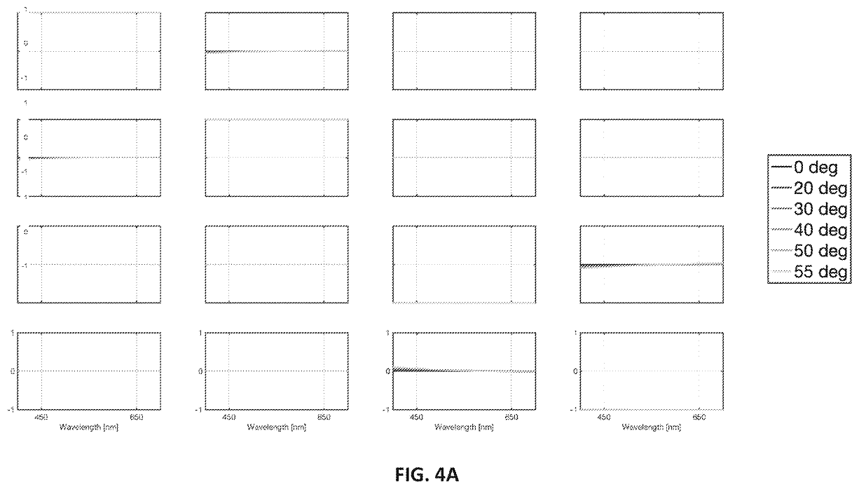

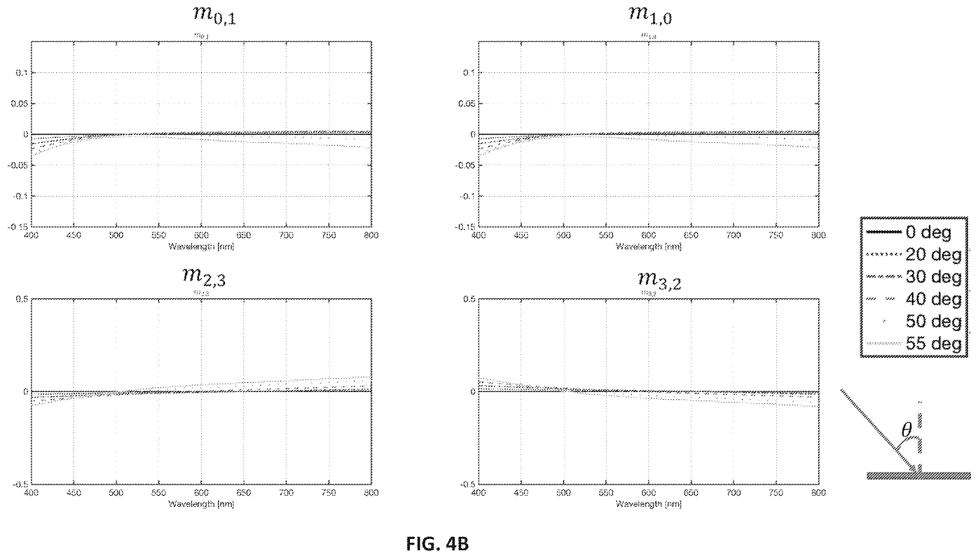

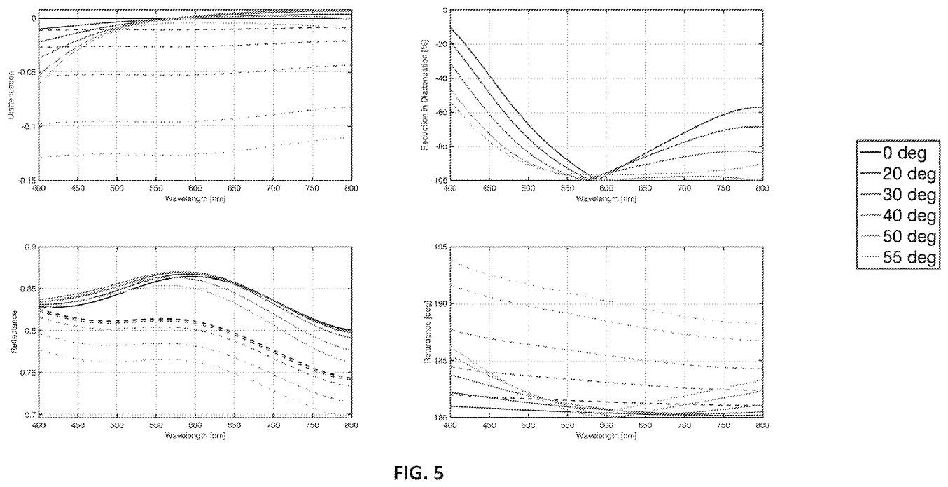

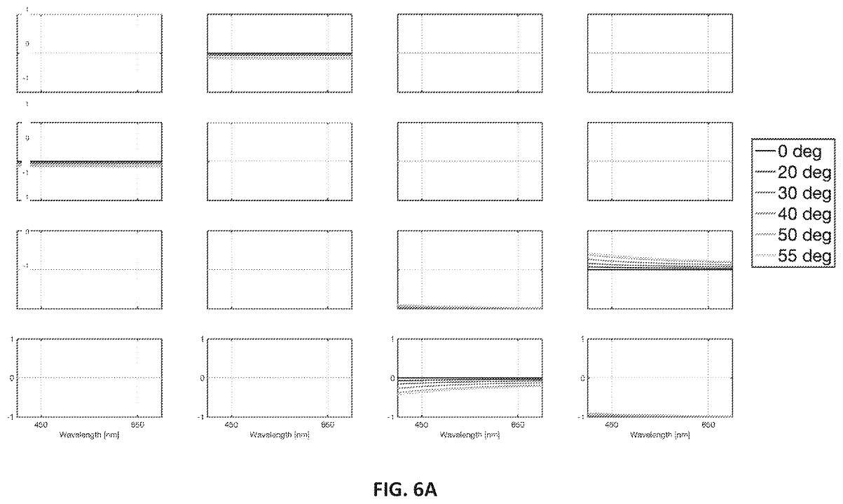

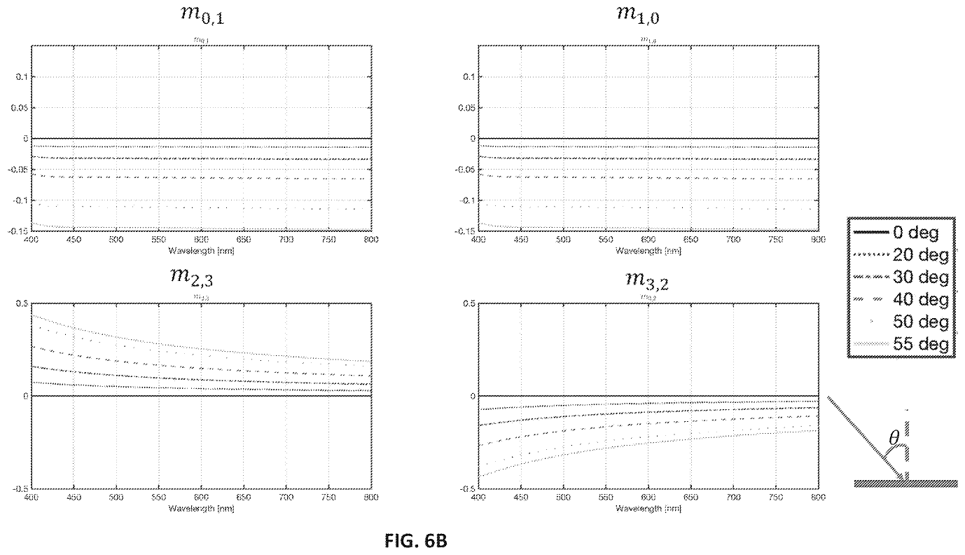

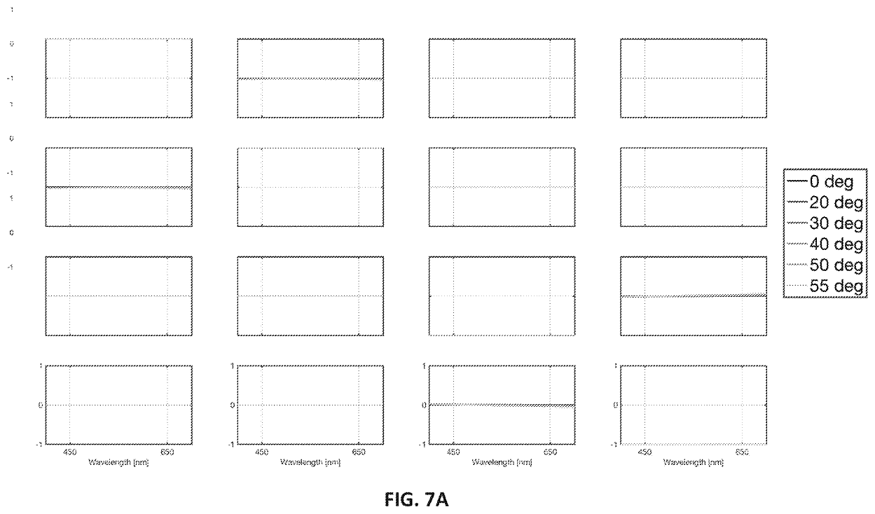

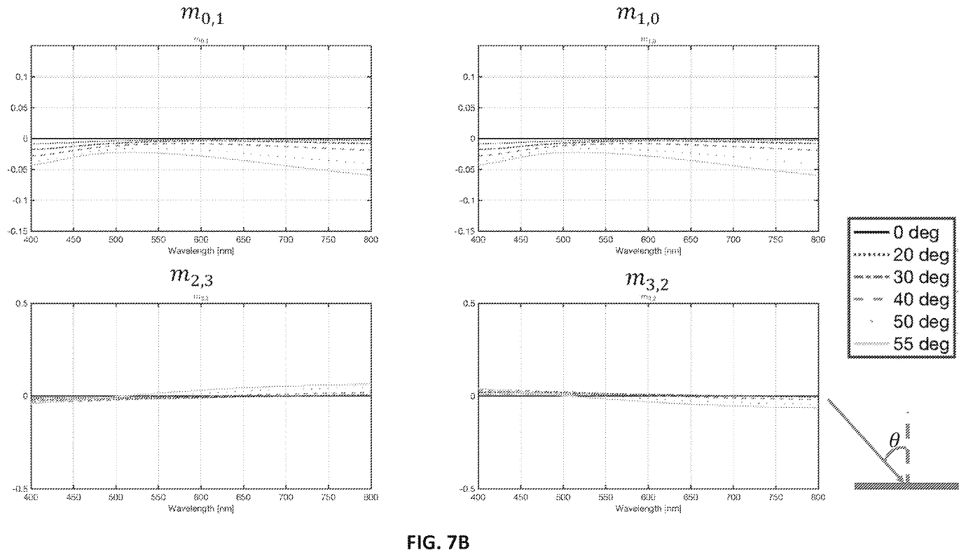

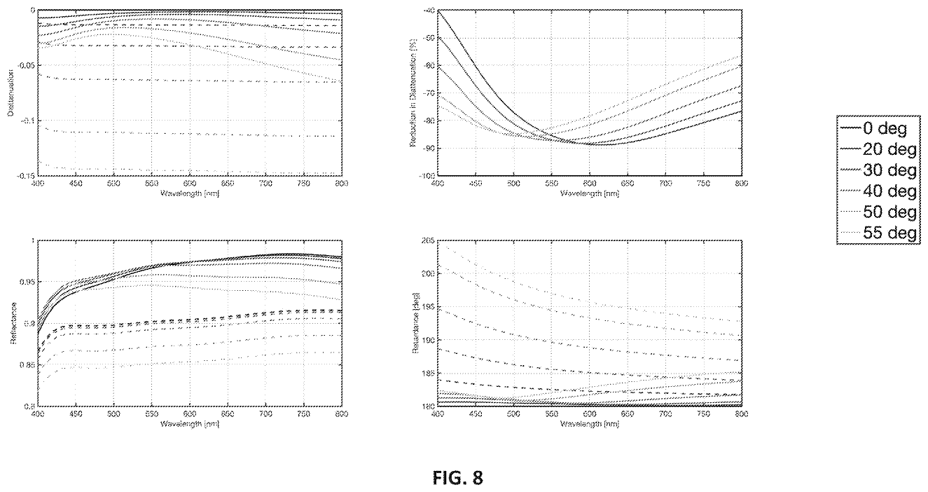

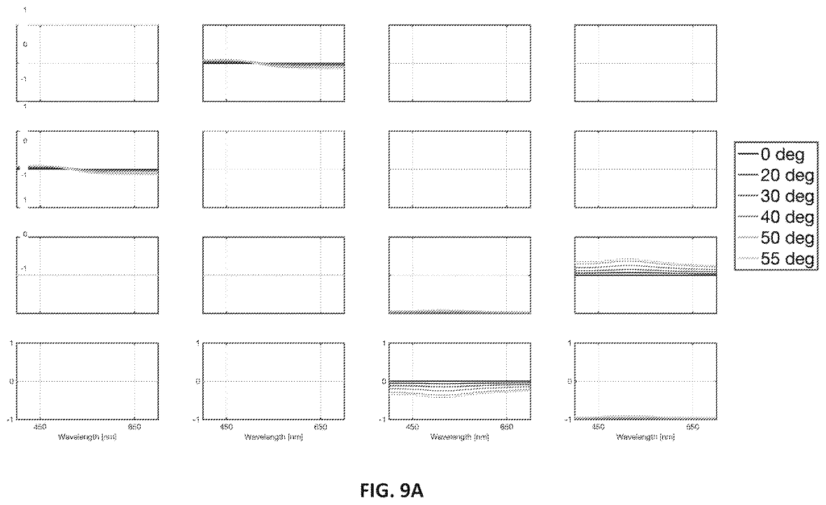

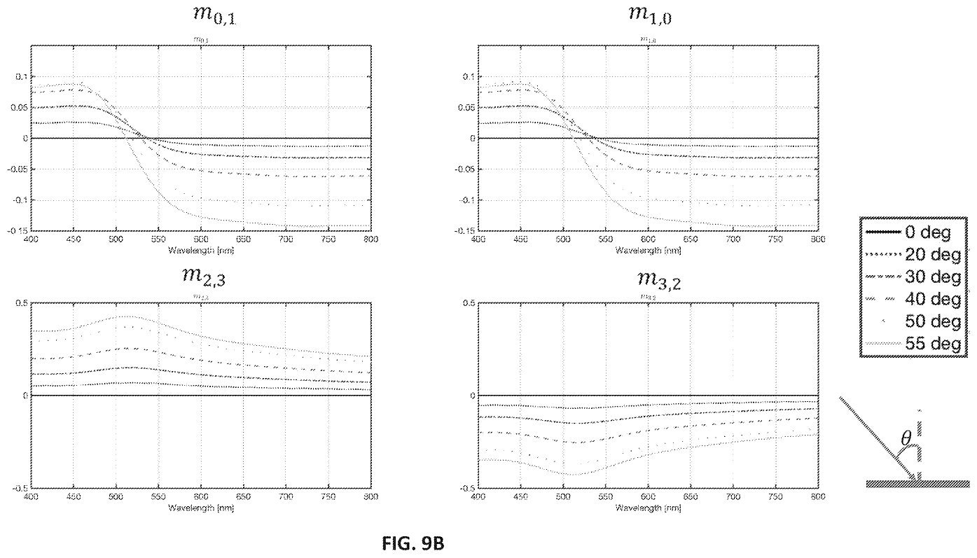

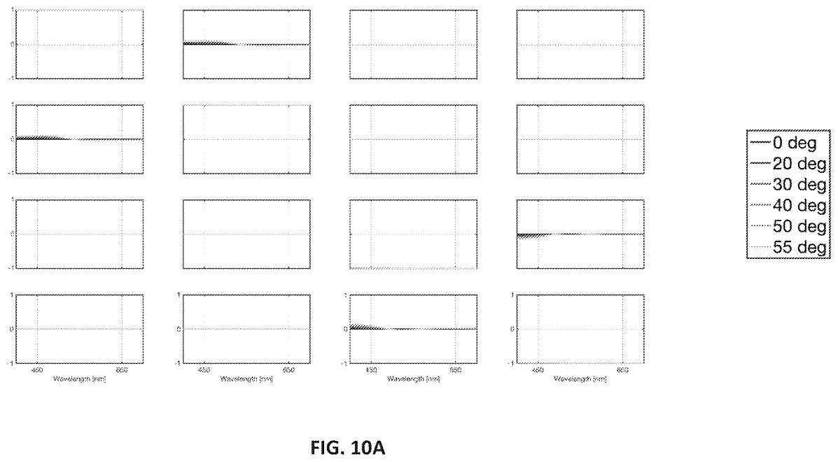

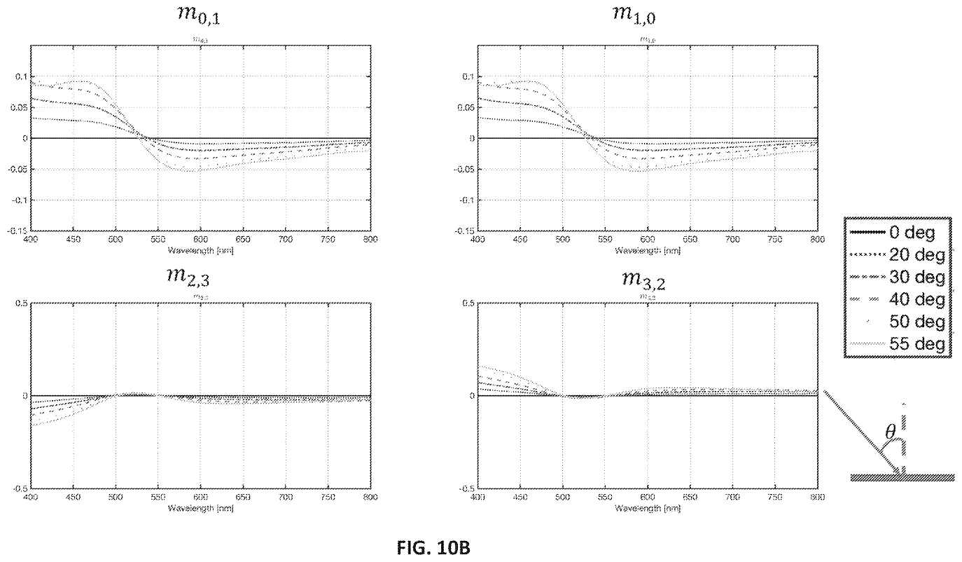

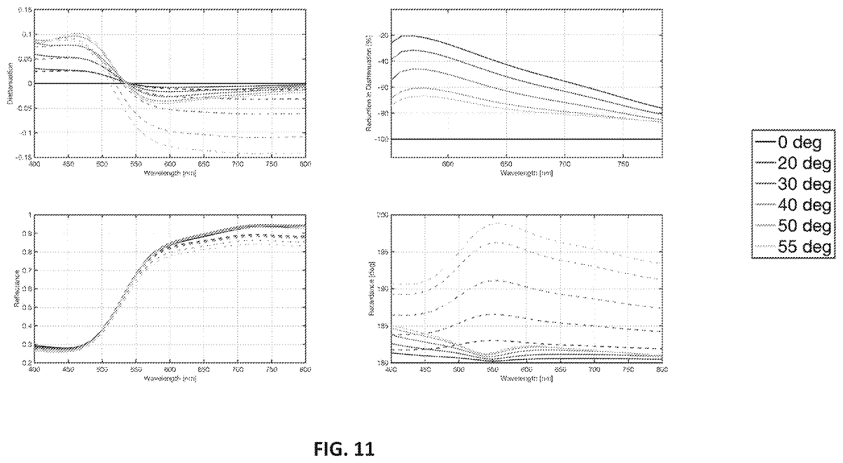

While aluminum was previously mentioned as an example reflective material, the method of correction according to the disclosed embodiments can be applied to other metals. Thicknesses of the AR coating and the uniaxial birefringent layer (e.g., C-plate layer) vary for differing metals. Original uncorrected Mueller matrices for aluminum, silver, and gold are shown in FIGS. 3A, 6A, and 9A, respectively (FIGS. 3B, 6B and 9B illustrate some of the magnified elements). These figures illustrate normalized Mueller matrices, showing polarization aberrations as a function of angle of incidence and wavelength for aluminum/silver/gold. Retardance is produced by the reflection from the metal, and diattenuation is produced by the Fresnel reflections from the negative C-plate and aluminum/silver/gold. The corrected Mueller matrices using negative C-plate and AR coating are in FIGS. 4A, 7A, and 10A, with FIGS. 4B, 7B and 10B illustrating magnified plots for some of the matrix elements. Important metrics, such as diattenuation, transmission, and retardance for the above examples are plotted in FIGS. 5, 8, and 11 after correction for configurations comprising aluminum, silver and gold, respectively. Dashed curves represent the original matrices for metals, whereas solid curves represent corrected matrices with the C-plate and AR coating in place. As can be seen, in for example FIG. 5, the design greatly reduces diattenuation, with close to 100% reduction in the range 500-600 nm. The retardance is also greatly reduced, approaching the ideal 180 degrees in the range 550-650 nm. The reflectance plots also indicate an improvement (bump) in certain spectral bands. FIG. 8 shows similar trends for sliver, indicating that even better corrections (compared to aluminum) can be achieved. In case of gold, as illustrated in FIG. 11, wavelengths shorter than 550 nm are preferentially absorbed by gold, making the correction at shorter wavelengths less effective.

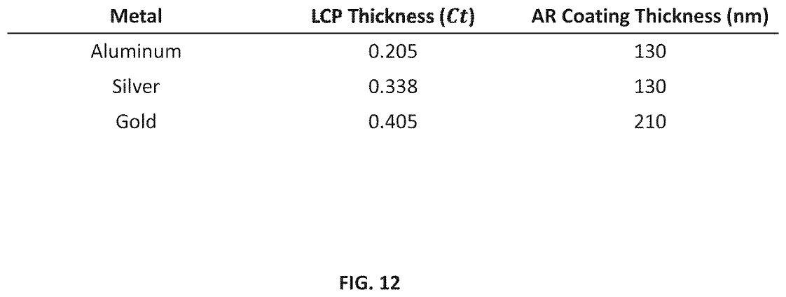

An example negative C-plate material is RMM1082, a commercially available liquid crystal polymer sold by EMD Electronics located in Philadelphia, PA, a subsidiary of Merck KGaA, Darmstadt, Germany; and an example AR coating is Teflon AF1601 amorphous fluoropolymer, available from DuPont de Nemours, Inc., Wilmington, DE. The optimized thicknesses for the negative C-plate material and AR coating are summarized in FIG. 12's Table 1 for aluminum, silver, and gold. By the way of example, and not by limitation, the table entries for Ct consist of three numbers after the decimal point, which allow the layer to be produced using typical manufacturing capabilities.

Ideal properties of the C-plate for this design would involve retardance dispersion and angular performance exactly matching that of the metal. LCP characteristics such as this would ensure the performance of the reflection from metal be as close to Equations (3) and (9) as possible. Birefringence of the LCP material must be high enough in the desired wavelength band for good correction, as well. For example, gold is widely used as a broadband reflector in the infrared (IR). LCP materials working in the visible spectra usually do not exhibit enough birefringence in the IR for adequate correction due to the normal dispersion of the LCP material. Additionally, ideal AR material would exhibit little to no dispersion, while maintaining a refractive index meeting the zero reflection criteria of:

$${n}_{1} = \sqrt{{n}_{0} {n}_{2}} \qquad ( 13 )$$

where, n₀=1 and n₂ is equal to the average refractive index of the birefringent LCP. The example designs described above utilize commercially available materials. For those skilled in the art, other designs using custom synthesized polymers with different birefringence and refractive indices can be realized to provide higher performances for different wavelength ranges and types of metal.

### Examples for Using Positive C-Plate for Metamaterial, Dye Doped C-Plate, Metal Coating with Partial Transmission, such as a Beamsplitter

Differing types of C-plate material may be necessary for different types of material. C-plate LCP is a uniaxial material, meaning the material has two refractive indices. These two refractive indices are defined as the ordinary refractive index and the extraordinary refractive index. The extraordinary refractive index is referred to as the c-axis as well. In a C-plate, the c-axis is perpendicular to the plane of the substrate. Positive C-plate material has an extraordinary refractive index larger than the ordinary refractive index. Negative C-plate material has an extraordinary refractive index less than the ordinary refractive index.

All optical materials have a refractive index which can be defined. Additionally, some materials exhibit absorption or gain, which is denoted with the refractive index as:

$$n = {n}_{R} + i κ \qquad ( 14 )$$

In Equation (14), n_{R} is the real refractive index and κ is the absorption or gain coefficient. In these calculations, the decreasing sign convention is used, so a positive κ denotes gain, while a negative κ denotes absorption. Retardance from reflection is not observed from dielectrics, as κ is zero-valued. Metals have a non-zero κ value, causing the retardance. The retardance from reflection on metals will always demonstrate that s-polarized light is the fast state, while p-polarized light is the slow state. Using a negative C-plate material, the retardance can be cancelled as the p-polarized state will be the fast state and the s-polarized state will be the slow state for the negative C-plate material. Other types of materials, such as metamaterials with a negative index of refraction and non-zero imaginary index will have the opposite fast and slow states as compared to metals. Additionally, reflection from materials with gain exhibit the same fast and slow states as lossy metamaterials. These types of reflections would require a positive C-plate to cancel the retardance from reflection.

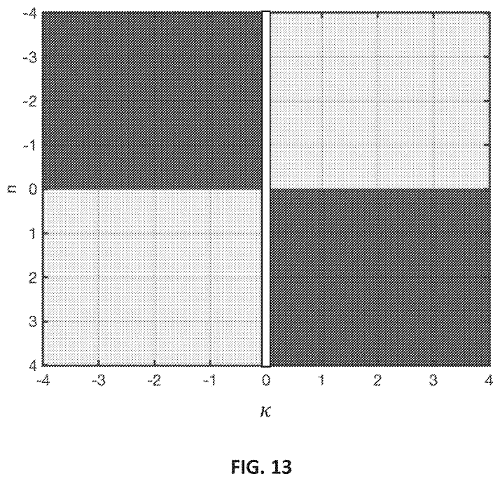

FIG. 13 illustrates classes of materials that are categorized in accordance with their n_{R} and κ values (i.e., the real index of refraction is plotted along the y-axis, while the imaginary component is along the x-axis). FIG. 13 further shows which type of C-plate would be required to correct retardance for each particular class of material. In particular, those materials which fall into the light gray zones (first and third quadrants) require negative C-plates, while those in dark gray zones (second and fourth quadrants) require positive C-plates. The narrow vertical white strip along the y-axis denotes materials which do not demonstrate retardance upon reflection, such as dielectrics.

Another application of a positive C-plate would be that of a dye-doped C-plate. Using a dichroic dye aligned in a liquid crystal matrix allows for the diattenuation from the metallic reflection to be cancelled. The dye-doped C-plate acts as a weak polarizer that equalizes the reflection amplitude of the s-polarized and p-polarized light. The overall transmission is reduced, but light is no longer preferentially polarized after reflection from the metal. Such a dye-doped C-plate can be used in addition to, or as an alternative to, using the AR layer. For example, in some embodiments, the dye-doped C-plate and the AR coating can be used to each partially correct the diattenuation (e.g., for different spectral bands or for the same spectral range).

It should be noted that while the above configurations have been described using flat layers or surfaces to facilitate the understanding of the disclosed concepts, it is understood that the disclosed embodiments can be used to correct polarization aberrations for curved (e.g., convex, concave or freeform) surfaces. For example, in some configurations, such surfaces may have large radii of curvature, which can be approximated by flat surfaces. In other configurations, the computations may be carried out for piecewise local flat areas that are subsequently combined. Further, more than one uniaxial birefringent layer and/or AR layers may be incorporated into the designs to meet the particular polarization aberration requirements. For example, each of the plurality of uniaxial birefringent layers (or AR layers) may be configured to provide correction for a particular spectral band. It should be further noted that the disclosed embodiments can be applied to correct (or provide a specific aberration) for all types of polarized light, including partially polarized light, since all polarizations are affected the same way.

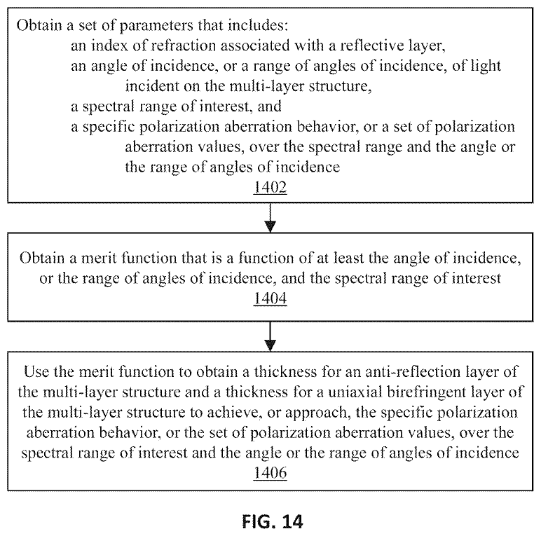

FIG. 14 illustrates a set of operations that can be carried out to provide a multi-layer structure that compensates for polarization aberrations in accordance with an example embodiment. At 1402 a set of parameters is obtained that includes: an index of refraction associated with a reflective layer, an angle of incidence, or a range of angles of incidence, of light incident on the multi-layer structure, a spectral range of interest, and a specific polarization aberration behavior, or a set of polarization aberration values, over the spectral range and the angle or the range of angles of incidence. At 1404, a merit function is obtained that is a function of at least the angle of incidence, or the range of angles of incidence, and the spectral range of interest. At 1406, the merit function is used to obtain a thickness for an anti-reflection layer of the multi-layer structure and a thickness for a uniaxial birefringent layer of the multi-layer structure to achieve, or approach, the specific polarization aberration behavior, or the set of polarization aberration values, over the spectral range of interest and the angle or the range of angles of incidence.

In one example embodiment, the specific polarization aberration behavior consists of a minimum retardance or diattenuation. In another example embodiment, the thickness of the anti-reflection layer is obtained to achieve a particular level of diattenuation associated with the multi-layer structure and the thickness of the uniaxial birefringent layer is obtained to achieve a particular level of retardance associated with the multi-layer structure. In yet another example embodiment, using the merit function includes optimizing the merit function based on a plurality of Mueller matrix elements associated with the multi-layer structure. In still another example embodiment, the uniaxial birefringent layer is a C-plate. In one example embodiment, the reflective layer is one of an aluminum layer, a silver layer, or a gold layer. In another example embodiment, the index of refraction of the reflective layer has a real part and an imaginary part, and (a) the real and imaginary parts of the index of refraction have the same sign with respect to each another, and the uniaxial birefringent layer is a negative C-plate layer, or (b) the real and imaginary parts of the index of refraction have opposite signs with respect to each another, and the uniaxial birefringent layer is a positive C-plate layer.

According to another example embodiment, the methods disclosed herein including the operations described in FIG. 14 and subsequent operations is performed by a device that includes a processor and a memory with instructions stored thereon. The instructions upon execution by the processor cause the processor to perform the aforementioned operations.

One aspect of the disclosed embodiments relates to an optical device that includes a multi-layer structure configured to compensate for polarization aberrations. The multi-layer structure includes a reflective layer having retardance and diattenuation over a particular range of wavelengths, and a uniaxial birefringent layer positioned above the reflective layer, the uniaxial birefringent layer having a thickness that is selected to compensate for at least a portion of the retardance associated with the reflective layer over the particular range of wavelengths. The multi-layer structure also includes an anti-reflection layer positioned above the uniaxial birefringent layer, the anti-reflection layer having a thickness that is selected to compensate for at least a portion of the diattenuation associated with the reflective layer over the particular range of wavelengths. The uniaxial birefringent layer and the anti-reflection layer are positioned to allow incident polarized light to pass through the anti-reflection layer and through the uniaxial birefringent layer to reach the reflective layer, and upon reflection from the reflective layer to pass through the uniaxial birefringent layer and then through anti-reflection layer.

In one example embodiment, the multi-layer structure further includes a substrate on which the reflective layer is positioned or coated. In another example embodiment, the uniaxial birefringent layer is a C-plate. In yet another example embodiment, the reflective layer is one of an aluminum layer, a silver layer or a gold layer. In still another example embodiment, the reflective layer has an index of refraction that includes a real part and an imaginary part. In some example embodiment, the reflective layer and the uniaxial birefringent layer are configured as one of the following: (a) the reflective layer has positive real and imaginary parts of the index of refraction and the uniaxial birefringent layer is a negative C-plate layer, (b) the reflective layer has negative real and imaginary parts of the index of refraction and the uniaxial birefringent layer is a negative C-plate layer, or (c) the reflective layer has real and imaginary parts of the index of refraction that have opposite signs with respect to one another, and the uniaxial birefringent layer is a positive C-plate.

According to another example embodiment, the reflective layer, the uniaxial birefringent layer and the anti-reflection layer all consist of substantially flat surfaces. In yet another example embodiment, the reflective layer, the uniaxial birefringent layer and the anti-reflection layer consist of one of convex, concave or freeform surfaces. In still another example embodiment, the multi-layer structure is configured to minimize the polarization aberrations over at least a portion of the particular range of wavelengths.

In one example embodiment, the multi-layer structure is configured to produce a specific level of the polarization aberrations over at least a portion of the particular range of wavelengths. In another example embodiment, the above noted optical device includes an additional uniaxial birefringent layer having a thickness that is selected to compensate for at least another portion of the retardance associated with the reflective layer over the particular range of wavelengths. In yet another example embodiment, the optical includes an additional anti-reflection layer having a thickness that is selected to compensate for at least another portion of the diattenuation associated with the reflective layer over the particular range of wavelengths. In still another example embodiment, the uniaxial birefringent layer is a dye-doped C-plate layer.

Another aspect of the disclosed embodiments relates to a multi-layer structure for compensating retardance and diattenuation over a particular range of wavelengths. The multi-layer structure includes a reflective layer having polarization aberrations, and a uniaxial birefringent layer positioned above the reflective layer, where the uniaxial birefringent layer has a thickness to compensate for at least a portion of the retardance associated with the multi-layer structure over the particular range of wavelengths. The multi-layer structure also includes an anti-reflection layer positioned above the uniaxial birefringent layer, the anti-reflection layer having a thickness to compensate for at least a portion of the diattenuation associated with the multi-layer structure over the particular range of wavelengths. The uniaxial birefringent layer and the anti-reflection layer are positioned to allow incident light to pass through the anti-reflection layer and through the uniaxial birefringent layer to reach the reflective layer, and upon reflection from the reflective layer to pass through the uniaxial birefringent layer and then through anti-reflection layer.

Another aspect of the disclosed embodiments relates to a multi-layer structure for compensating retardance and diattenuation over a particular range of wavelengths. The multi-layer structure includes a reflective layer having polarization aberrations, and a uniaxial birefringent layer positioned above the reflective layer, the uniaxial birefringent layer having a thickness and material to compensate for at least a portion of the retardance and diattenuation associated with the reflective layer over the particular range of wavelengths. The uniaxial birefringent layer is a dye-doped C-plate layer.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to receive desired polarization aberration characteristics, desired spectral bands, range of angles of incidence, types and properties of the materials and other parameters, and to process the received information to determine the proper designs and thicknesses of the layers to produce the desired polarization aberration characteristics in accordance with the disclosed technology.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. An optical device, comprising:
a multi-layer structure configured to compensate for polarization aberrations, the multi-layer structure including:
a reflective layer having retardance and diattenuation over a particular range of wavelengths,
a uniaxial birefringent layer positioned above the reflective layer, the uniaxial birefringent layer having a thickness that is selected to compensate for at least a portion of the retardance associated with the reflective layer over the particular range of wavelengths, and
an anti-reflection layer positioned above the uniaxial birefringent layer, the anti-reflection layer having a thickness that is selected to compensate for at least a portion of the diattenuation associated with the reflective layer over the particular range of wavelengths, wherein
the uniaxial birefringent layer and the anti-reflection layer are positioned to allow incident polarized light to pass through the anti-reflection layer and through the uniaxial birefringent layer to reach the reflective layer, and upon reflection from the reflective layer to pass through the uniaxial birefringent layer and then through anti-reflection layer.

2. The optical device of claim 1, further including a substrate on which the reflective layer is positioned or coated.

3. The optical device of claim 1, wherein the uniaxial birefringent layer is a C-plate.

4. The optical device of claim 1, wherein the reflective layer is one of an aluminum layer, a silver layer or a gold layer.

5. The optical device of claim 1, wherein the reflective layer has an index of refraction that includes a real part and an imaginary part.

6. The optical device of claim 5, wherein the reflective layer and the uniaxial birefringent layer are configured as one of the following:
the reflective layer has positive real and imaginary parts of the index of refraction and the uniaxial birefringent layer is a negative C-plate layer,
the reflective layer has negative real and imaginary parts of the index of refraction and the uniaxial birefringent layer is a negative C-plate layer, or
the reflective layer has real and imaginary parts of the index of refraction that have opposite signs with respect to one another, and the uniaxial birefringent layer is a positive C-plate.

7. The optical device of claim 1, wherein the reflective layer, the uniaxial birefringent layer and the anti-reflection layer all consist of substantially flat surfaces.

8. The optical device of claim 1, wherein the reflective layer, the uniaxial birefringent layer and the anti-reflection layer consist of one of convex, concave or freeform surfaces.

9. The optical device of claim 1, wherein the multi-layer structure is configured to minimize the polarization aberrations over at least a portion of the particular range of wavelengths.

10. The optical device of claim 1, wherein the multi-layer structure is configured to produce a specific level of the polarization aberrations over at least a portion of the particular range of wavelengths.

11. The optical device of claim 1, comprising an additional uniaxial birefringent layer having a thickness that is selected to compensate for at least another portion of the retardance associated with the reflective layer over the particular range of wavelengths.

12. The optical device of claim 1, comprising an additional anti-reflection layer having a thickness that is selected to compensate for at least another portion of the diattenuation associated with the reflective layer over the particular range of wavelengths.

13. The optical device of claim 1, wherein the uniaxial birefringent layer is a dye-doped C-plate layer.

14. A multi-layer structure for compensating retardance and diattenuation over a particular range of wavelengths, comprising:
a reflective layer having polarization aberrations,
a uniaxial birefringent layer positioned above the reflective layer, the uniaxial birefringent layer having a thickness to compensate for at least a portion of the retardance associated with the multi-layer structure over the particular range of wavelengths, and
an anti-reflection layer positioned above the uniaxial birefringent layer, the anti-reflection layer having a thickness to compensate for at least a portion of the diattenuation associated with the multi-layer structure over the particular range of wavelengths, wherein
the uniaxial birefringent layer and the anti-reflection layer are positioned to allow incident light to pass through the anti-reflection layer and through the uniaxial birefringent layer to reach the reflective layer, and upon reflection from the reflective layer to pass through the uniaxial birefringent layer and then through anti-reflection layer.

15. A multi-layer structure for compensating retardance and diattenuation over a particular range of wavelengths, comprising:
a reflective layer having polarization aberrations, and
a uniaxial birefringent layer positioned above the reflective layer, the uniaxial birefringent layer having a thickness and material to compensate for at least a portion of the retardance and diattenuation associated with the reflective layer over the particular range of wavelengths, wherein
the uniaxial birefringent layer is a dye-doped C-plate layer.

16. A method for providing a multi-layer structure that compensates for polarization aberrations, the method including:
obtaining a set of parameters that includes:
an index of refraction associated with a reflective layer,
an angle of incidence, or a range of angles of incidence, of light incident on the multi-layer structure,
a spectral range of interest, and
a specific polarization aberration behavior, or a set of polarization aberration values, over the spectral range and the angle or the range of angles of incidence,
obtaining a merit function that is a function of at least the angle of incidence, or the range of angles of incidence, and the spectral range of interest; and
using the merit function to obtain a thickness for an anti-reflection layer of the multi-layer structure and a thickness for a uniaxial birefringent layer of the multi-layer structure to achieve, or approach, the specific polarization aberration behavior, or the set of polarization aberration values, over the spectral range of interest and the angle or the range of angles of incidence.

17. The method of claim 16, wherein the specific polarization aberration behavior consists of a minimum retardance or diattenuation.

18. The method of claim 16, wherein the thickness of the anti-reflection layer is obtained to achieve a particular level of diattenuation associated with the multi-layer structure and the thickness of the uniaxial birefringent layer is obtained to achieve a particular level of retardance associated with the multi-layer structure.

19. The method of claim 16, wherein using the merit function includes optimizing the merit function based on a plurality of Mueller matrix elements associated with the multi-layer structure.

20. The method of claim 16, wherein the uniaxial birefringent layer is a C-plate.

21. The method of claim 16, wherein the reflective layer is one of an aluminum layer, a silver layer, or a gold layer.

22. The method of claim 16, wherein the index of refraction of the reflective layer has a real part and an imaginary part, and wherein:
the real and imaginary parts of the index of refraction have the same sign with respect to each another, and the uniaxial birefringent layer is a negative C-plate layer, or
the real and imaginary parts of the index of refraction have opposite signs with respect to each another, and the uniaxial birefringent layer is a positive C-plate layer.

23. (canceled)
